(19) United States
(12) Patent Application Publication
(10) Pub. No.: US 2025/0097868 A1
(43) Pub. Date: Mar. 20, 2025

(54) MEASUREMENT METHOD AND MEASUREMENT DEVICE BASED ON SYNCHRONIZATION SIGNAL AND PBCH BLOCK INDEXES

(71) Applicant: Samsung Electronics Co., Ltd., Suwon-si (KR)

(72) Inventor: Jia ZHU, Suzhou (CN)

(73) Assignee: Samsung Electronics Co., Ltd., Suwon-si (KR)

(21) Appl. No.: 18/789,947

(22) Filed: Jul. 31, 2024

(30) Foreign Application Priority Data
Sep. 19, 2023 (CN) 202311211165.9

(51) Int. Cl. H04W 56/00; H04W 24/10; H04W 64/00

(52) U.S. Cl. CPC H04W 56/0015; H04W 24/10; H04W 64/00

(57) ABSTRACT

A measurement method and a measurement device based on synchronization signal and PBCH block (SSB) indexes are provided. The measurement method includes adding a first SSB index corresponding to a first SSB into a first measurement candidate set based on the first SSB having a first measured signal quality value greater than a threshold, and measuring a signal quality value for each SSB corresponding to a respective SSB index in the first measurement candidate set in a first SSB measurement period.

### CROSS-REFERENCE TO RELATED APPLICATION

This application is based on and claims priority under 35 U.S.C. § 119 to Chinese Patent Application No. 202311211165.9, filed on Sep. 19, 2023 in the Chinese Intellectual Property Office, the disclosure of which is hereby incorporated by reference herein in its entirety.

### TECHNICAL FIELD

The disclosure relates to a communication technology field, and in particular, to a measurement method and a measurement device based on synchronization signal and PBCH block indexes.

### BACKGROUND

Due to the introduction of an SSB (Synchronization Signal and physical broadcast channel (PBCH) block) for search and synchronization of a terminal in 5G (fifth generation) according to settings of different bandwidths, subcarrier widths and related network parameters, SSB signals may be assigned to a plurality of specific symbols and transmitted on beams to ensure an effective cell-wide coverage.

When the terminal is to perform serving cell and neighboring cell measurements, a measurement object configured by the network is the SSB and the network parameter ssbTomeasure (indicating the location information of actual occurrence of the SSB in an SSB burst set) may not be set. Currently, in such circumstances, the physical layer of the terminal performs measurement based on the PCI (Physical Cell Identifier) and SSB frequencies provided by RRM (Radio Resource Management). This measurement method always measures all possible SSBs in the cell, which lacks flexibility, and is a waste of measurement resources and terminal power consumption when SSB information does not exist in some SSB burst sets.

### SUMMARY

Example embodiments provided below address one or more of the above challenges.

According to an aspect of example embodiments, there is provided a measurement method based on synchronization signal and PBCH block (SSB) indexes, the method includes adding a first SSB index corresponding to a first SSB into a first measurement candidate set based on the first SSB having a first measured signal quality value greater than a threshold, and measuring a signal quality value for each SSB corresponding to a respective SSB index in the first measurement candidate set in a first SSB measurement period.

The method may also include measuring first respective signal quality values for SSBs corresponding to all SSB indexes among a first set of SSB indexes in a second SSB measurement period, the second SSB measurement period preceding the first SSB measurement period.

The adding the first SSB index into the first measurement candidate set may be performed based on the first SSB measurement period not satisfying a time interval condition, and the method may also include measuring second respective signal quality values for SSBs corresponding to all SSB indexes among a first set of SSB indexes in a third SSB measurement period based on the third SSB measurement period satisfying the time interval condition.

The method may also include measuring third respective signal quality values for SSBs corresponding to all SSB indexes among the first set of SSB indexes in a fourth SSB measurement period to obtain a plurality of signal quality values, performing a first operation in response to at least one of the plurality of signal quality values being greater than the threshold, the first operation including adding each respective SSB index among the first set of SSB indexes for which a corresponding SSB has a signal quality value greater than the threshold and at least one first adjacent SSB index into a second measurement candidate set, the at least one first adjacent SSB index being adjacent to the respective SSB index, and performing a second operation in response to none of the plurality of signal quality values being greater than the threshold, the second operation including adding a second SSB index among the first set of SSB indexes and at least one second adjacent SSB index into the second measurement candidate set, the second SSB index corresponding to an SSB having a highest signal quality value among the plurality of signal quality values, and the at least one second adjacent SSB index being adjacent to the second SSB index.

The method may also include measuring third respective signal quality values for SSBs corresponding to all SSB indexes among the first set of SSB indexes in a fourth SSB measurement period to obtain a plurality of signal quality values, adding each respective SSB index among the first set of SSB indexes for which a corresponding SSB has a signal quality value greater than the threshold into a second measurement candidate set in response to at least one of the plurality of signal quality values being greater than the threshold, and skipping measurement of a signal quality value for each SSB corresponding to a respective SSB index in the second measurement candidate set in a fifth SSB measurement period in response to the second measurement candidate set being empty.

The time interval condition may be based on an interval number of SSB measurement periods.

The method may also include adding a number of SSB indexes of a polling sequence into the first measurement candidate set after the adding the first SSB index into the first measurement candidate set, the polling sequence including all SSB indexes among a first set of SSB indexes in ascending or descending order.

The number of SSB indexes may be a difference between a first number and a candidate number, the candidate number being the number of SSB indexes included in the first measurement candidate set prior to the adding the number of SSB indexes to the first measurement candidate set being performed, and the adding the number of the SSB indexes into the first measurement candidate set may be performed in response to the candidate number being less than or equal to the first number.

The adding the number of SSB indexes of the polling sequence into the first measurement candidate set may include adding SSB indexes of the polling sequence that are not the same as SSB indexes already in the first measurement candidate set.

The method may also include setting a value of a first counter for the first SSB to 2, subtracting 1 from a value of a second counter for a second SSB, the second SSB having a signal quality value less than or equal to the threshold, and adding each respective SSB index among a second set of SSB indexes corresponding to an SSB having a counter with a value greater than 0 into the first measurement candidate set, the second set of SSB indexes including SSB indexes corresponding to SSBs having measured signal quality values less than or equal to the threshold, and the adding each respective SSB index into the first measurement candidate set being performed before the adding the number of SSB indexes into the first measurement candidate set.

The first set of SSB indexes may include all SSB indexes in an SSB burst set in response to location information of occurrence of SSBs in the SSB burst set not being configured, and the first set of SSB indexes may include SSB indexes indicated by the location information in response to the location information being configured.

The method may further include clearing the first measurement candidate set after the measuring the signal quality value in the first SSB measurement period, and repeating the adding the first SSB index corresponding to the first SSB into the first measurement candidate set based on the first SSB having a second measured signal quality greater than the threshold into the first measurement candidate set after the clearing.

According to an aspect of example embodiments, there is provided a measurement device based on synchronization signal and PBCH block (SSB) indexes, the device includes processing circuitry configured to add a first SSB index corresponding to a first SSB into a first measurement candidate set based on the first SSB having a first measured signal quality value greater than a threshold, and measure a signal quality value for each SSB corresponding to a respective SSB index in the first measurement candidate set in a first SSB measurement period.

The processing circuitry may be configured to measure first respective signal quality values for SSBs corresponding to all SSB indexes among a first set of SSB indexes in a second SSB measurement period, the second SSB measurement period preceding the first SSB measurement period.

The processing circuitry may be configured to add the first SSB index into the first measurement candidate set based on the first SSB measurement period not satisfying a time interval condition, and measure second respective signal quality values for SSBs corresponding to all SSB indexes among a first set of SSB indexes in a third SSB measurement period based on the third SSB measurement period satisfying the time interval condition.

The processing circuitry may be configured to measure third respective signal quality values for SSBs corresponding to all SSB indexes among the first set of SSB indexes in a fourth SSB measurement period to obtain a plurality of signal quality values, perform a first operation in response to at least one of the plurality of signal quality values being greater than the threshold, the first operation including adding each respective SSB index among the first set of SSB indexes for which a corresponding SSB has a signal quality value greater than the threshold and at least one first adjacent SSB index into a second measurement candidate set, the at least one first adjacent SSB index being adjacent to the respective SSB index, and perform a second operation in response to none of the plurality of signal quality values being greater than the threshold, the second operation including adding a second SSB index among the first set of SSB indexes and at least one second adjacent SSB index into the second measurement candidate set, the second SSB index corresponding to an SSB having a highest signal quality value among the plurality of signal quality values, and the at least one second adjacent SSB index being adjacent to the second SSB index.

The processing circuitry may be configured to measure third respective signal quality values for SSBs corresponding to all SSB indexes among the first set of SSB indexes in a fourth SSB measurement period to obtain a plurality of signal quality values, add each respective SSB index among the first set of SSB indexes for which a corresponding SSB has a signal quality value greater than the threshold into a second measurement candidate set in response to at least one of the plurality of signal quality values being greater than the threshold, and skipping measurement of a signal quality value for each SSB corresponding to a respective SSB index in the second measurement candidate set in a fifth SSB measurement period in response to the second measurement candidate set being empty.

The time interval condition may be based on an interval number of SSB measurement periods.

The processing circuitry may be configured to add a number of SSB indexes of a polling sequence into the first measurement candidate set after the addition of the first SSB index into the first measurement candidate set, the polling sequence including all SSB indexes among a first set of SSB indexes in ascending or descending order.

The number of SSB indexes may be a difference between a first number and a candidate number, the candidate number being the number of SSB indexes included in the first measurement candidate set prior to the addition of the number of SSB indexes to the first measurement candidate set, and the processing circuitry may be configured to add the number of the SSB indexes into the first measurement candidate set in response to the candidate number being less than or equal to the first number.

None among the number of the SSB indexes of the polling sequence added into the first measurement candidate set may not be the same as an SSB index already in the first measurement candidate set.

The processing circuitry may be configured to set a value of a first counter for the first SSB to 2, subtract 1 from a value of a second counter for a second SSB, the second SSB having a signal quality value less than or equal to the threshold, and add each respective SSB index among a second set of SSB indexes corresponding to an SSB having a counter with a value greater than 0 into the first measurement candidate set, the second set of SSB indexes including SSB indexes corresponding to SSBs having measured signal quality values less than or equal to the threshold, and the addition of each respective SSB index into the first measurement candidate set being performed before the addition of the number of SSB indexes into the first measurement candidate set.

The first set of SSB indexes may include all SSB indexes in an SSB burst set in response to location information of occurrence of SSB in the SSB burst set not being configured, and the first set of SSB indexes may include SSB indexes indicated by the location information in response to the location information being configured.

The processing circuitry may be configured to clear the first measurement candidate set after the measurement of the signal quality value in the first SSB measurement period, and repeat the addition of the first SSB index corresponding to the first SSB into the first measurement candidate set based on the first SSB having a second measured signal quality greater than the threshold after the first measurement candidate set is cleared.

According to an aspect of example embodiments, there is provided an electronic apparatus, the apparatus may include at least one processor, and a memory storing a computer program that, when executed by the at least one processor, causes the at least one processor to perform a method, the method including adding a first synchronization signal and PBCH block (SSB) index corresponding to a first SSB into a first measurement candidate set based on the first SSB having a first measured signal quality value greater than a threshold, and measuring a signal quality value for each SSB corresponding to a respective SSB index in the first measurement candidate set in a first SSB measurement period.

According to an aspect of example embodiments, there is provided a non-transitory computer readable storage medium storing a computer program that, when executed by processing circuitry, causes the processing circuitry to perform a method, the method including adding a first synchronization signal and PBCH block (SSB) index corresponding to a first SSB into a first measurement candidate set based on the first SSB having a first measured signal quality value greater than a threshold, and measuring a signal quality value for each SSB corresponding to a respective SSB index in the first measurement candidate set in a first SSB measurement period.

The technical solutions provided according to example embodiments of this disclosure bring at least the following beneficial effects: by selecting the SSB index corresponding to the SSB with the measured signal quality greater than a threshold to be measured in the next SSB measurement period, measurements are focused on one or some SSB indexes corresponding to the SSBs, which avoids (or reduces) the measurements of invalid SSBs and weak SSBs, and conserves measurement resources as well as terminal power consumption.

It should be understood that the above general description and the later detailed description are examples and explanatory only and do not limit the present disclosure.

### BRIEF DESCRIPTION OF THE DRAWINGS

The above and other aspects will be more apparent from the following description of example embodiments in conjunction with the accompanying drawings, in which:

FIG. 1 illustrates a basic architecture of an SSB measurement system according to example embodiments;

FIG. 2 illustrates a flowchart of a measurement method based on SSB indexes according to example embodiments;

FIG. 3 illustrates a specific flowchart of measurement method I based on SSB indexes according to example embodiments;

FIG. 4 illustrates a specific flowchart of measurement method II based on SSB indexes according to example embodiments;

FIG. 5 illustrates a specific flowchart of measurement method III based on SSB indexes according to example embodiments;

FIG. 6 illustrates a specific flowchart of measurement method IV based on SSB indexes according to example embodiments;

FIG. 7 illustrates a diagram of a measurement method based on SSB indexes according to example embodiments;

FIG. 8 illustrates a block diagram of a measurement device based on SSB indexes according to example embodiments; and

FIG. 9 illustrates a block diagram of an electronic apparatus according to example embodiments.

### DETAILED DESCRIPTION

Hereinafter, example embodiments are described with reference to the accompanying drawings, in which like reference numerals are used to depict the same or similar elements, features, and structures. Example embodiments described herein are examples, and thus, the present disclosure is not limited thereto, and may be realized in various other forms. Example embodiments provided in the following description are not excluded from being associated with one or more features of each other, or with one or more features not provided herein but consistent with the present disclosure.

As used herein, the terms “1st” or “first,” and “2nd” or “second,” may use corresponding components regardless of importance or order, and are used to distinguish a component from another component without limiting the components. It will be also understood that, although in example embodiments related to methods or flowcharts, an operation is described later than another operation, the operation may be performed earlier than (or contemporaneous with) the other operation unless the operation is described as being performed after the other operation. Example embodiments described herein do not represent all examples that are consistent with the disclosure. Rather, example embodiments described herein are examples of devices and methods that are consistent with some aspects of the disclosure, as detailed in the appended claims.

Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The synchronization signal and PBCH block (SSB) introduced in 5G includes a primary synchronization signal (PSS), a secondary synchronization signal (SSS) and a physical broadcast channel (PBCH). Compared to long-term evolution (LTE), the SSBs in 5G are more flexible in time and frequency domain configuration, and thus, more complex. Since 5G is deployed in high frequency bands and coverage area of a cellular base station is relatively small, some broadcast information is transmitted not in the form of coverage but in the form of beam sweeping. Therefore, 5G uses the beam sweeping to cover the entire cell, that is, the base station transmits beams in different directions at a plurality of times to cover the entire cell, wherein each beam is configured with PSS, SSS and PBCH, and transmitted simultaneously (or contemporaneously) to enable downlink synchronization for the UE. Therefore, the PSS, SSS and PBCH are collectively referred to as the SSB in 5G. According to example embodiments, each SSB transmitted in a burst set corresponds to a different beam (e.g., beam pattern) transmitted by the base station apparatus 102.

Since the SSB is transmitted by the beam sweeping, one cell usually sends a plurality of SSBs to complete one beam sweeping in order for the synchronization signal to cover the entire cell service area. The plurality of SSBs used to complete the beam sweeping form one SSB burst set, and the plurality of SSBs in the SSB burst set are indicated by SSB indexes (e.g., the SSB indexes indicate which number (e.g., identify) the SSB is in the SSB burst set). When the system frequency is less than or equal to 3G, the maximum (or highest) number of SSBs (SSB beams) in the SSB burst set is 4. When the system frequency is greater than 3G and less than or equal to 6G (sixth generation), the maximum (or highest) number of SSBs in the SSB burst set is 8, and when the system frequency is greater than 6G, the maximum (or highest) number of SSBs (SSB beams) in the SSB burst set is 64.

When the terminal is to perform serving cell and neighboring cell measurements, a measurement object configured by the network may be the SSB. In such circumstances current measurement includes: 1) the radio resource management (RRM) in the terminal (e.g., user equipment (UE)) first triggers the measurement according to SSB frequencies set in radio resource control (RRC) configuration information. 2) the physical layer (PHY) in the terminal feeds back measurement results to the RRM, including signal qualities (e.g., reference signal receiving power, RSRP) of all measured SSBs and the physical cell identifier (PCI) of the cell. 3) the RRM triggers a next measurement request when a next period arrives, and future measurement is based on the SSB frequencies and the PCI.

When the SSB is measured by the terminal, if ssbTomeasure is not set, the terminal according to the current measurement method is only able to perform measurement based on the SSBs corresponding to all SSB indexes, and does not know (e.g., does not have access to information indicating) which SSB index is available (which SSB corresponding to the SSB index is transmitted). Even in cases in which the ssbTomeasure is set, in general only some SSBs with sufficiently strong signal quality (e.g., RSRP) are useful to determine the behavior of the UE, and thus it is not necessary to measure the SSBs corresponding to all SSB indexes (or all SSB indexes indicated by the ssbTomeasure). This measurement method lacks flexibility and wastes measurement resources as well as terminal power due to the measurement of invalid SSBs and weak SSBs. Here, an invalid SSB may be the SSB that is not transmitted by the base station (or cell) (or the SSB corresponding to the SSB index is not transmitted), and a weak SSB may be the SSB with signal quality below a specific threshold (e.g., below a measurement report threshold).

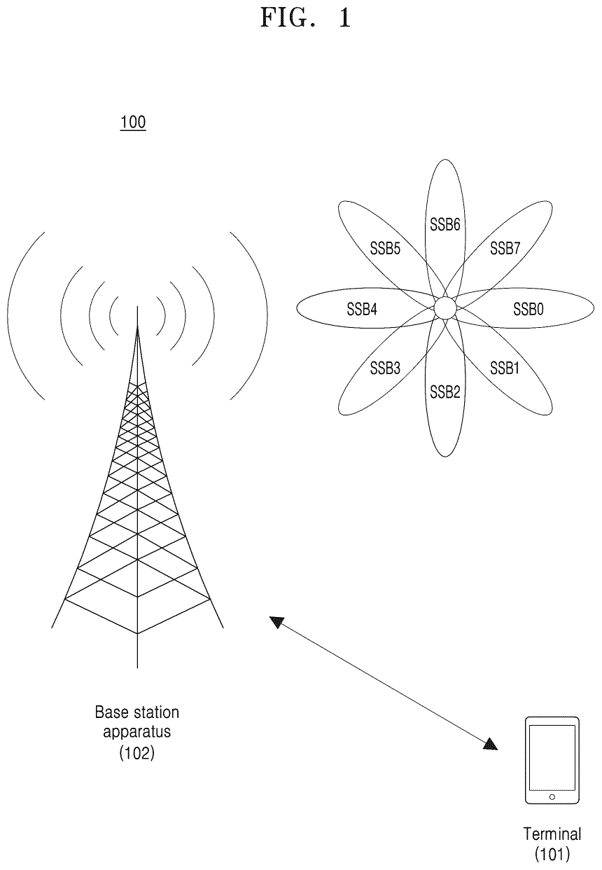

To address the above issues, example embodiments provide a measurement method and a measurement device based on synchronization signal and PBCH block (SSB) indexes. By selecting SSB indexes corresponding to SSBs with the measured signal quality greater than a threshold to be measured in the next SSB measurement period, measurements are focused on SSBs corresponding to one or some SSB indexes, which avoids (or reduces) measurements of invalid SSBs and weak SSBs, and thus, saves measurement resources as well as terminal power. Hereinafter, the measurement method and the measurement device based on synchronization signal and PBCH block (SSB) indexes according to the disclosure are described specifically with reference to FIGS. 1 to 9.

FIG. 1 illustrates a basic architecture of an SSB measurement system according to example embodiments, and as shown in FIG. 1, the SSB measurement system 100 may include a terminal 101 and/or a base station apparatus 102, and the terminal 101 may communicate with the base station apparatus 102 and/or may communicate with another terminal via the base station apparatus 102. The terminal may be a mobile terminal, such as a cell phone, a tablet, a desktop, a laptop, a handheld computer, a notebook, etc., and the terminal may also be a wearable device (such as a smart watch, a smart bracelet, smart glasses, a head-mounted display (HMD)), a netbook, a personal digital assistant (PDA), an augmented reality (AR) apparatus, or a virtual reality (VR) apparatus) etc., and the disclosure is not limited thereto. The terminal may also be referred to as a user unit, a user station, a mobile station, a mobile station, a remote station, an access point, a remote terminal, an access terminal, a user terminal, a user equipment (UE), or a user agent. The base station apparatus 102 may be a base station in a 5G system, a base station (BTS) in a global system for mobile communication (GSM) system or code division multiple access (CDMA) system, a base station (NodeB) in a wideband CDMA (WCDMA) system, or an evolved base station (eNB) in an LTE system, an access point (AP), a relay station, etc. The disclosure is not limited thereto.

As shown in FIG. 1, the cell under the base station apparatus 102 transmits a plurality of SSBs to cover the entire service area of the cell, and the SSBs are transmitted by beam sweeping. For FR1 band (e.g., when the base station apparatus 102 communicates using a first frequency band), the maximum (or highest) number of SSBs (SSB beams) in the SSB burst set is 8, and for FR2 band (e.g., when the base station apparatus 102 communicates using a second frequency band), the maximum (or highest) number of SSBs (SSB beams) in the SSB burst set is 64, wherein the range of the FRI band is 450 MHz˜6000 MHz (also referred to as sub6G) with a maximum (or highest) system bandwidth of 100 MHz, and the range of the FR2 band is 24250 MHz˜52600 MHz (5G millimeter wave band) with a maximum (or highest) system bandwidth of 400 MHz. In the SSB measurement method of the present disclosure, the terminal may get to know (e.g., may determine) the frequency band of the cell to be measured, and may get to know (e.g., may determine) a possible maximum (or highest) number of SSBs in the SSB burst set (e.g., 8 or 64) of the cell according to the frequency band of the cell, and then the maximum (or highest) number of SSBs may be measured as the number of beams in the SSB burst set without configuring ssbTomeasure. A possible maximum (or highest number of SSBs) of 8 SSB beams in the SSB burst set is illustrated in FIG. 1, corresponding to SSB indexes 0-7. The terminal (e.g., UE) 101 performs the measurement of the SSBs (SSBs in the SSB burst set) of the cell under the base station apparatus 102. The measurement operation on the terminal 101 side involves the operation of the PHY layer (not shown) and the operation of the RRM (not shown), wherein the PHY refers to the physical layer (layer 1) in the protocol stack and the RRM is the radio resource management module and may be located on layer 2 in the protocol stack, and the PHY and the RRM operate in conjunction to implement the SSB measurement method on the terminal side.

It should be understood that the description of the basic architecture of the SSB measurement system here is only an example and the disclosure is not limited thereto. Also, the number of SSBs in the SSB burst set and the SSB index representation here are only examples, and the disclosure is not limited thereto.

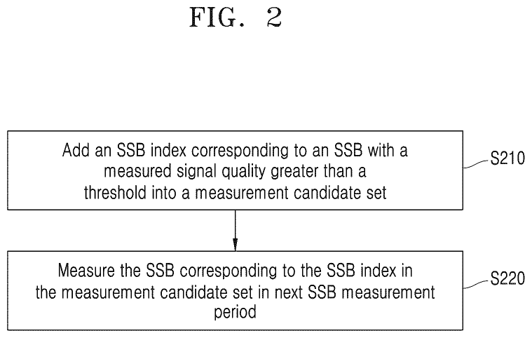

FIG. 2 illustrates a flowchart of a measurement method based on SSB indexes according to example embodiments. The flowchart of the method illustrated in FIG. 2 may be performed by the terminal 101.

In example embodiments, an SSB measurement may be a measurement for a serving cell or a neighboring cell by the terminal 101, may be an intra-frequency measurement or an inter-frequency measurement, and may also be a measurement of the terminal 101 in a connected state or an idle state, and the disclosure is not limited thereto.

Referring to FIG. 2, in operation S210, an SSB index corresponding to an SSB with a measured signal quality greater than a predetermined (or alternatively, given) threshold is added into a measurement candidate set. Here, the measured signal quality is the signal quality obtained by measuring the SSB in the current SSB measurement period, and the signal quality may include (e.g., may be measured based on) one or more of reference signal receiving power (RSRP), reference signal receiving quality (RSRQ), signal to interference plus noise ratio (SINR), etc., and the disclosure is not limited thereto.

According to example embodiments, SSBs corresponding to all SSB indexes are measured in a first SSB measurement period. The measured signal quality may be the signal qualities obtained by measuring the SSBs corresponding to all SSB indexes (e.g., a first set of SSB indexes). In the case of location information (e.g., ssbTomeasure) of actual occurrence of the SSB in an SSB burst set not being configured, the all SSB indexes are (e.g., the first set of SSB indexes includes) all SSB indexes in the SSB burst set, and in the case of the location information being configured, the all SSB indexes are (e.g., the first set of SSB indexes includes) the SSB indexes indicated by the location information. According to example embodiments, when the location information has been configured the first set of SSB indexes includes only those SSB indexes indicated by the location information. According to example embodiments, when the location information has not been configured, the first set of SSB indexes includes all SSB indexes included among the possible maximum (or highest) number of SSBs in the SSB burst set (e.g., 8 or 64) of the cell determined according to the frequency band of the cell. According to example embodiments, configuring (and/or setting) the location information may include receiving the location information (e.g., the network parameter ssbTomeasure) from the base station apparatus 102.

The terminal may obtain the location information of actual occurrence of the SSB in the SSB burst set, e.g., ssbTomeasure, via the system information block (SIB) (e.g., SIB2). Specifically, the parameter of the ssbTomeasure is represented by a bitmap in the following three configured forms: shortBitmap: length of 4 bit, applicable to system frequency<=3 GHZ, and the maximum number of SSBs in the SSB burst set is 4; mediumBitmap: length of 8 bit, applicable to 3 GHZ<system frequency<=6 GHZ, and the maximum number of SSBs in the SSB burst set is 8; longBitmap: length of 64 bit, applicable to system frequency>6 GHz, and the maximum number of SSBs in the SSB burst set is 64.

In the example implementation, in the first SSB measurement period (e.g., the current SSB measurement period is the first SSB measurement period), taking the SSB measurement by a terminal in the connected state as an example, the RRM in the terminal triggers the measurement according to SSB frequencies configured in the RRC signaling. If the terminal side is configured with the location information (e.g., the ssbTomeasure) of the actual occurrence of the SSB in the SSB burst set, the measurements are performed for the SSBs corresponding to the SSB indexes indicated by the ssbTomeasure. If the ssbTomeasure is not configured on the terminal side, the measurements are performed for all SSB indexes in the SSB burst set. The ssbTomeasure may indicate the terminal in the form of a bitmap to which SSB indexes the SSBs corresponding are to be measured. For example, taking the SSB burst set in the cell under the base station apparatus 102, shown in FIG. 1, with possible maximum (or highest) number of 8 SSBs as an example, if the ssbTomeasure is configured (e.g., the ssbTomeasure adopts an 8-bit bitmap to indicate that SSBs corresponding to SSB indexes 0-3 are to be measured), the terminal only measures the SSBs corresponding to the indicated SSB indexes (e.g., SSBs corresponding to the SSB indexes 0-3). If the ssbTomeasure is not configured, the terminal measures all the total 8 SSBs in the SSB burst set in this cell. Here, the RRM in the terminal instructs the PHY layer of the terminal to perform the SSB measurements after the SSBs to be measured (e.g., the SSBs corresponding to all SSB indexes in the burst set or the SSB indexes indicated by the ssbTomeasure) are determined.

In example embodiments, in operation S210, when the current SSB measurement period is not the first SSB measurement period, the measured signal quality may be the signal qualities obtained by measuring the SSBs corresponding to all SSB indexes or the signal qualities obtained by measuring the SSBs corresponding to the SSB indexes in the measurement candidate set.

In practice, only some SSBs with sufficiently strong signal quality are useful for determining the behavior of the terminal (e.g., UE), and thus after the PHY layer of the terminal performs the measurement and reports the measurement results to the RRM, and the RRM adds the SSB index corresponding to the SSB with the measured signal quality greater than the predetermined (or alternatively, given) threshold in the current SSB measurement period into the measurement candidate set. In the following, the SSB index to be added into the measurement candidate set may be referred to as a candidate SSB index.

According to example embodiments, the predetermined (or alternatively, given) threshold may be a first threshold, the SSB index corresponding to the SSB with signal quality greater than the first threshold and its adjacent SSB indexes may be added into the measurement candidate set, and the SSB index corresponding to the SSB with a maximum (or highest) value in the signal qualities and its adjacent SSB indexes may be added into the measurement candidate set in the case of all signal qualities being less than or equal to the first threshold.

According to example embodiments, the predetermined (or alternatively, given) threshold may be a second threshold, and the SSB index corresponding to the SSB with the signal quality greater than the second threshold may be added into the measurement candidate set.

In example embodiments, the selection of the predetermined (or alternatively, given) threshold involves the following two measurement methods:

In measurement method I, the predetermined (or alternatively, given) threshold is the first threshold, which may be a default value, an empirical value, and/or vary depending on the specific parameter selected (e.g., RSRP or RSRQ), and the disclosure is not limited thereto. In one aspect of the measurement method I, the RRM may add the SSB index corresponding to the SSB with signal quality greater than the first threshold and its adjacent SSB indexes into the measurement candidate set, where the adjacent SSB indexes may be two adjacent SSB indexes.

For example, if the current SSB measurement period is the first SSB measurement period and the ssbTomeasure is not configured, the terminal measures all the total 8 SSBs (SSB indexes 0-7) in the set of SSB burst in the cell, and the SSB index corresponding to the SSB with the measured signal quality greater than the first threshold is 4, then the candidate SSB indexes may be {3,4,5}, wherein SSB indexes 3 and 5 are the two adjacent SSB indexes of the SSB index 4. Here, the two adjacent SSB indexes are only examples, the adjacent SSB indexes may also be three adjacent SSB indexes, accordingly, the candidate SSB indexes may be {2,3,4,5} or {3,4,5,6}, and they may also be four adjacent SSB indexes, accordingly, the candidate SSB indexes may be {2,3,4,5,6}. The disclosure does not limit the number of adjacent SSB indexes and the selection method. In addition, in the case that the SSB index corresponding to the SSB with the measured signal quality greater than the first threshold is 7, the candidate SSB indexes may be {5,6,7} since there is no adjacent SSB index on the right side, that is, the two adjacent SSB indexes on its left side are selected. Similarly, in the case of there being no adjacent SSB indexes on the left side, the candidate SSB indexes may be the two adjacent SSB indexes on its right side. In addition, in the case that the SSB indexes corresponding to the SSB with the measured signal quality greater than the first threshold are 4 and 5, the SSB index corresponding to the SSB with the greatest signal quality (e.g., 4) and its adjacent SSB indexes are considered first, and the candidate SSB indexes at this time are {3,4,5}. And then the SSB index 5 corresponding to the SSB with signal quality also greater than the first threshold and its adjacent SSB indexes are considered, the candidate SSB indexes at this time are {4,5,6}, and accordingly the final candidate SSB indexes may be {3,4,5,6} excluding the duplicate SSB indexes.

For another example, in the case that the current SSB measurement period is the first SSB measurement period and the ssbTomeasure is configured, the terminal measures the SSBs corresponding to the SSB indexes indicated by the ssbTomeasure. The SSB indexes indicated by ssbTomeasure may be, for example, {1,3,5,7}, then the indexes close to (neighboring) each other in {1,3,5,7} may be used as adjacent SSB indexes. For example, SSB indexes 1 and 5 may be used as the two adjacent SSB indexes of SSB index 3, and SSB indexes 3 and 7 may be used as the two adjacent SSB indexes of SSB index 5. And at this time, the adjacent SSB indexes may be selected in the same manner as described above.

On the other hand of measurement method I, the RRM adds the SSB index corresponding to the SSB with the maximum (or highest) value in the signal qualities and its adjacent SSB indexes into the measurement candidate set in the case of all the measured signal qualities being less than or equal to the first threshold, and the adjacent SSB indexes may be the two adjacent SSB indexes. For example, in the case that the current SSB measurement period is the first SSB measurement period and ssbTomeasure is not configured, the terminal measures all the total 8 SSBs (SSB indexes 0-7) in the SSB burst set in the cell, however, the signal qualities obtained from all 8 SSB measurements are less than or equal to the first threshold, the RRM may add the SSB index (e.g., 3) corresponding to the SSB with the maximum (or highest) value of the signal quality and its adjacent SSB indexes (e.g., 2 and 4) into the measurement candidate set (candidate SSB indexes are {2,3,4}). Herein, the two adjacent SSB indexes are only examples, and the adjacent SSB indexes may also be the three or four adjacent SSB indexes, and the disclosure is not limited thereto. The adjacent SSB indexes may be selected in the same manner as described above.

In measurement method II, the predetermined (or alternatively, given) threshold is the second threshold, and the second threshold may be set with reference to the signal quality of a serving cell in the A3 event (e.g., an intra-frequency handover or an inter-frequency handover), and/or may be set by the operator. For example, when the measured signal quality is RSRP (e.g., an RSRP measurement), the second threshold may be set to a value that is 5 dB less than the signal quality of the serving cell in the A3 event. The above setting of the second threshold is only an example and the disclosure is not limited thereto. In the measurement method II, the RRM may add the SSB index corresponding to the SSB with signal quality greater than the second threshold into the measurement candidate set. For example, in the case that the current SSB measurement period is the first SSB measurement period and the ssbTomeasure is configured, the terminal measures the SSBs corresponding to the SSB indexes indicated by the ssbTomeasure, and the SSB indexes indicated by the ssbTomeasure may be, for example, {0,1,2,3}. After the SSBs corresponding to the above SSB indexes are measured by the PHY layer and reported to the RRM, the RRM finds that the signal quality of only the SSB corresponding to the SSB index 1 is greater than the second threshold, then the RRM adds the SSB index 1 into the measurement candidate set. Unlike the measurement method I, in the measurement method II, there may be a case that the measurement candidate set is empty.

The A3 event is a switching event, and the A3 event switching is triggered when the measured signal quality of a neighboring cell is one absolute threshold (e.g., 3 dB) higher than the serving cell. For example, when the signal quality of the serving cell is −70 dB and the signal quality of the neighboring cell is −67 dB, the A3 event switching is triggered, switching from the serving cell to that neighboring cell. When the SSB measurement is performed on an neighboring cell, the second threshold for the neighboring cell may be set smaller than the signal quality of the serving cell for the A3 event (e.g., −70 dB) by a buffer value (e.g., a buffer value of 5 dB), i.e., the second threshold for the neighboring cell may be set to the signal quality of the serving cell—the buffer value (e.g., −75 dB). In the case of selecting the second threshold according to the above, the measurement candidate set of some neighboring cells may be empty, thereby avoiding SSB measurements of neighboring cells with poor signal quality and focusing on measurements of those neighboring cells with better signal quality and in which switching may occur.

In operation S220, the SSB corresponding to the SSB index in the measurement candidate set is measured in the next SSB measurement period (e.g., an SSB measurement period subsequent to the first measurement period). Here, the SSB indexes in the measurement candidate set are indicated by the RRM to the PHY layer of the terminal in the next SSB measurement period, and the SSBs corresponding to these indexes are measured by the PHY layer.

According to example embodiments of the disclosure, in the next SSB measurement period, measurements may be performed only for the SSBs corresponding to the SSB indexes in the measurement candidate set (e.g., without measuring the signal quality of SSBs not included in the measurement candidate set), and the SSB indexes in the measurement candidate set are the SSB indexes that were measured and filtered in the previous SSB measurement period, which conserves measurement resources as well as terminal power consumption while avoiding (or reducing) measurements of invalid SSBs and weak SSBs.

According to example embodiments, the predetermined (or alternatively, given) threshold is the second threshold, and no measurement is performed in the next SSB measurement period in the case of the measurement candidate set being empty.

In example embodiments, in the measurement method II, there may be a case that the measurement candidate set is empty because of the special choice (e.g., the determination) of the second threshold (for example, when the measured signal quality is RSRP, the second threshold may be set to a value that is 5 dB less than the signal quality of the serving cell in the A3 event). In the case of the measurement candidate set being empty, no measurement is performed in the next SSB measurement period.

According to example embodiments, after the operation of measuring the SSBs corresponding to the SSB indexes in the measurement candidate set, the measurement method based on the SSB index may further includes clearing the measurement candidate set (e.g., removing all SSB indexes from the measurement candidate set such that the measurement candidate set is empty) and returning to the operation of adding the SSB index corresponding to the SSB with a measured signal quality greater than the predetermined (or alternatively, given) threshold into the measurement candidate set.

In example embodiments, after the SSBs corresponding to the candidate SSB indexes in the measurement candidate set are measured and the measured signal qualities are obtained (after operation S220), the measurement candidate set may be cleared (the measurement candidate set is empty). The procedure returns to continue with operation S210, that is, to determine whether the signal quality measured for the SSB corresponding to the candidate SSB index is greater than the predetermined (or alternatively, given) threshold, and the SSB index corresponding to the SSB with signal quality greater than the predetermined (or alternatively, given) threshold is added into the measurement candidate set again. In this way, operation S210 and operation S220 may form a loop.

For example, taking the above measurement method I as an example, without configuring the ssbTomeasure, in SSB measurement period 1 (the first SSB measurement period), the terminal performs the measurements for all the total 8 SSBs (SSB index 0-7) in the SSB burst set in the cell, and the SSB index corresponding to the SSB with the measured signal quality greater than the first threshold is 4. The SSB index 4 and its two adjacent SSB indexes are added into the measurement candidate set, and the measurement candidate set is {3,4,5}. In SSB measurement period 2, the terminal measures the SSBs corresponding to SSB indexes 3, 4 and 5 in the measurement candidate set {3,4,5} and clears the measurement candidate set after the measurement. If the SSB index corresponding to the SSB with measured signal quality greater than the first threshold is 5, then SSB index 5 and its two adjacent SSB indexes are added into the measurement candidate set, and the measurement candidate set is {4,5,6}. In SSB measurement period 3, the terminal measures the SSBs corresponding to SSB indexes 4, 5 and 6 in the measurement candidate set {4,5,6}, and subsequent SSB measurement periods are performed in the same manner (or a similar manner). According to example embodiments, after the measurement candidate set is cleared, SSB indexes may be added to the measurement candidate set based on corresponding signal quality measurements obtained in the SSB measurement period 2, without re-measuring the signal quality for all 8 SSBs as in the SSB measurement period 1.

According to example embodiments, in the case of the next SSB measurement period not satisfying a predetermined (or alternatively, given) time interval (e.g., a time interval condition), the operation of adding the SSB index corresponding to the SSB with the measured signal quality greater than a predetermined (or alternatively, given) threshold into the measurement candidate set may be performed, and in the case of the next SSB measurement period satisfying the predetermined (or alternatively, given) time interval, SSBs corresponding to all SSB indexes may be measured in the next SSB measurement period. The predetermined (or alternatively, given) time interval is a predetermined (or alternatively, given) interval number of SSB measurement periods.

After the above operation S210 and operation S220 form a loop, the SSBs corresponding to the SSB indexes in the measurement candidate set generated in the previous SSB measurement period are measurement objects in the next SSB measurement period, and the measurement objects have a small range of variation. However, when the terminal moves or in other cases, an ideal measurement object may not be among the SSBs indicated by the SSB indexes in the measurement candidate set or may even be far from the indicated SSBs. Moreover, in the above measurement method II, there may be a case that the measurement candidate set is empty. Therefore, in example embodiments, in the case that the next SSB measurement period satisfies a predetermined (or alternatively, given) time interval, the measurement candidate set is not generated in the current SSB measurement period, and the SSBs corresponding to all SSB indexes are measured at the arrival of the next SSB measurement period. Here, in the case of the ssbTomeasure not being configured, the all SSB indexes are all SSB indexes in the SSB burst set, and in the case of the ssbTomeasure being configured, the all SSB indexes are the SSB indexes indicated by the ssbTomeasure.

In example embodiments, the next SSB measurement period satisfies the predetermined (or alternatively, given) time interval (e.g., the time interval condition), specifically, which may be that the system frame number (SNF) of the next SSB measurement period satisfies: SNF mod NT=(FLOOR (Offset/10)), wherein T=CEIL (Periodicity/10), Periodicity is the SSB measurement period, and Offset is the time domain position offset of the SSB, and N (e.g., a predetermined (or alternatively, given) interval number) indicates the interval number of time (SSB measurement period) to measure the SSBs corresponding to all SSB indexes, for example, the predetermined (or alternatively, given) interval number N may be set to 4 for the FR1 band and 8 for the FR2 band. For example, the SSB period is 20 ms, and the time domain position offset (Offset) of the SSB is 18, and the SSB measurement period may be, for example, 20 ms, 40 ms or 80 ms, and the SSB measurement period (Periodicity) being also 20 ms is taken as an example. When the predetermined (or alternatively, given) interval number N is set to 4, according to the above formula, SNF mod 8=1, since the frame length corresponds to 10 ms, the predetermined (or alternatively, given) time interval is 80 ms (e.g., the predetermined (or alternatively, given) interval number N of SSB measurement periods (20 ms), here Nis 4). As a result, the terminal may measure the SSBs corresponding to all SSB indexes in the next SSB measurement period with the SNF of 1, 9, 17 . . . . In other words, in the case of the next SSB measurement period satisfying the predetermined (or alternatively, given) time interval of 4 SSB measurement periods, the SSBs corresponding to all SSB index are measured at the arrival of the next SSB measurement period. It should be understood that the above predetermined (or alternatively, given) interval number is only an example, and the disclosure is not limited thereto.

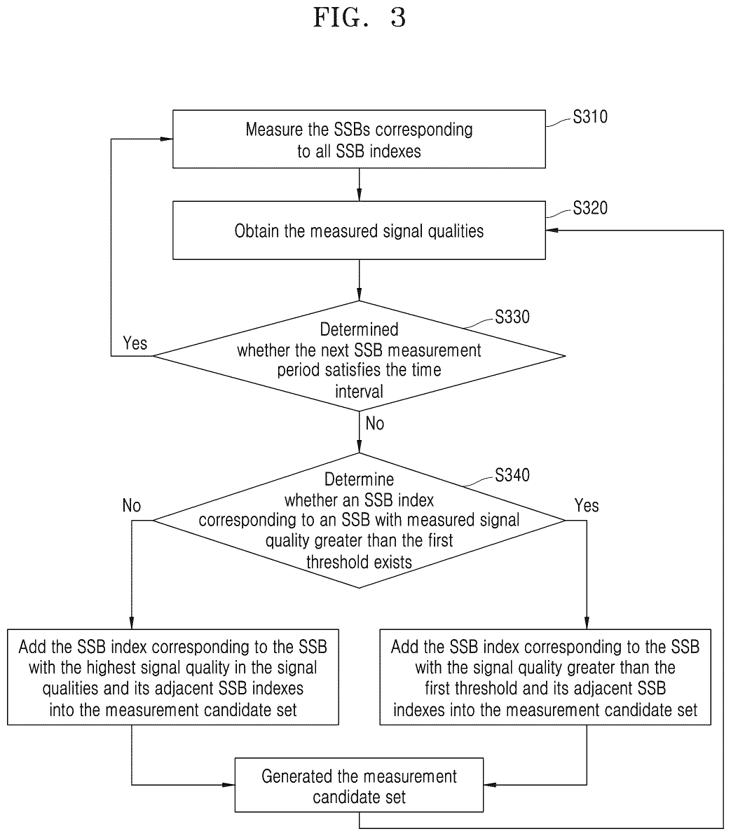

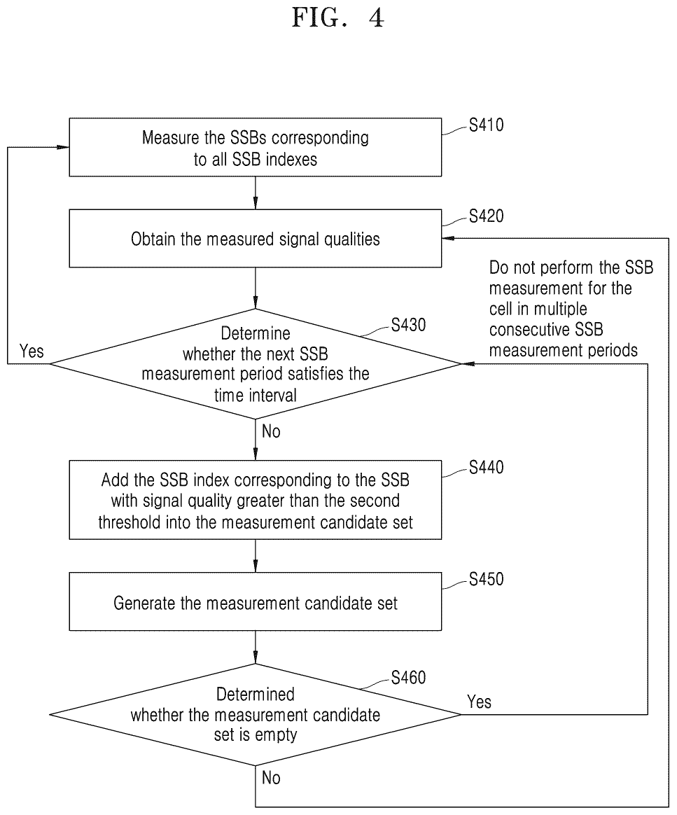

The specific flows of the measurement method I and the measurement method II are described below with reference to FIGS. 3 and 4. FIG. 3 illustrates a specific flowchart of measurement method I based on SSB indexes according to example embodiments. In the measurement method I, the predetermined (or alternatively, given) threshold is the first threshold.

Referring to FIG. 3, in operation S310, the SSBs corresponding to all SSB indexes are measured. Specifically, after the SSB measurement starts, the RRM of the terminal instructs the PHY layer to measure the SSBs corresponding to all SSB indexes at the current SSB measurement period (e.g., period P, where P is a positive integer). Operation S310 may measure the SSBs corresponding to all SSB indexes in the first SSB measurement period, or it may measure the SSBs corresponding to all SSB indexes at the arrival of the next SSB measurement period (e.g., the current SSB measurement period) in the case of the next SSB measurement period satisfying the predetermined (or alternatively, given) time interval.

In operation S320, the measured signal qualities are obtained. Specifically, it may be that the PHY reports the measured signal qualities to the RRM, whereby the measured signal qualities are obtained by the RRM. Here the measured signal qualities may be the signal qualities measured for the SSBs corresponding to all SSB indexes, or they may be the signal qualities measured for the SSBs corresponding to the SSB indexes in the measurement candidate set.

In operation S330, it is determined whether the next SSB measurement period satisfies the predetermined (or alternatively, given) time interval, specifically, it may be determined whether the SNF of the next SSB measurement period (e.g., period P+1) satisfies the condition of SNF mod NT=(FLOOR (Offset/10)), where T=CEIL (Periodicity/10), Periodicity is the SSB measurement period, and Offset is the time domain position offset of the SSB, and N (e.g., the predetermined (or alternatively, given) interval number) indicates the interval number of time (SSB measurement period) to measure the SSBs corresponding to all SSB indexes, and N may be set to 4 for the FR1 band and to 8 for the FR2 band.

In the case that the condition is satisfied (determined result of “yes”), the measurement candidate set is not generated and at the arrival of the next SSB measurement period (e.g., period P+1), the procedure proceeds to operation S310, the SSBs corresponding to all SSB indexes are measured. In the case that it is not satisfied (determined result of “No”), the measurement candidate set should be generated, and the procedure proceeds to operation S340.

In operation S340, it is determined whether an SSB index corresponding to an SSB with measured signal quality greater than the first threshold exists. In the case of existence (determined result of “yes”), the procedure proceeds to operation S350, and in the operation S350, the SSB index corresponding to the SSB with the signal quality greater than the first threshold and its adjacent SSB indexes are added into the measurement candidate set. In the case of no existence (determined result of “No”), the procedure proceeds to operation S360, and in the operation S360, the SSB index corresponding to the SSB with the maximum (or highest) value in the signal qualities and its adjacent SSB indexes are added into the measurement candidate set.

In operation S370, the measurement candidate set is generated. The measurement candidate set is generated from the SSB indexes of operation S350 or operation S360. The above operations S330-S370 may be operated by the RRM of the terminal.

In addition, in the case of the measurement candidate set being generated, at the arrival of the next SSB measurement period (e.g., period P+1), measurements may be performed only for the SSBs corresponding to the SSB indexes in the measurement candidate set. Specifically, the terminal RRM instructs the PHY layer to measure the SSB corresponding to the SSB index in the measurement candidate set, and the procedure proceeds to operation S320 again to obtain the measured signal qualities. Here, the measurement candidate set may be cleared by the RRM after the PHY layer of the terminal measures the SSBs corresponding to the SSB indexes in the measurement candidate set and reports the measured signal qualities to the RRM (e.g., after operation S320).

FIG. 4 illustrates a specific flowchart of measurement method II based on SSB indexes according to example embodiments. In the measurement method II, the predetermined (or alternatively, given) threshold is the second threshold.

Referring to FIG. 4, operations S410-S430 in FIG. 4 are the same as (or similar to) operations S310-S330 in FIG. 3, and thus redundant descriptions are omitted.

In operation S440, the SSB index corresponding to the SSB (e.g., any SSB) with signal quality greater than the second threshold is added into the measurement candidate set. In operation S450, the measurement candidate set is generated, the measurement candidate set is generated from the SSB indexes in operation S440.

In operation S460, it is determined whether the measurement candidate set is empty. In the case of the measurement candidate set being empty (determined result of “yes”), the SSB measurement is not performed in the next SSB measurement period (e.g., period P+1), and the procedure proceeds to operation S430, in which it is determined whether the next SSB measurement period (e.g., period P+2) satisfies the predetermined (or alternatively, given) time interval. In the case of the next SSB measurement period (e.g., period P+2) not satisfying the predetermined (or alternatively, given) time interval, the terminal will not perform SSB measurements for the cell in multiple consecutive SSB measurement periods (e.g., period P+1, period P+2, etc.). Until it is determined that the next SSB measurement period (e.g., period P+4) satisfies the predetermined (or alternatively, given) time interval in operation S430, and at the arrival of the next SSB measurement period (e.g., period P+4), the procedure proceeds to operation S410, and in operation S410, the SSBs corresponding to all SSB indexes are measured.

In the case of the measurement candidate set not being empty (determined result of “No”), at the arrival of the next SSB measurement period (e.g., period P+1), the measurements are performed only for the SSBs corresponding to the SSB indexes in the measurement candidate set, and the procedure proceeds to operation S420, the measured signal qualities are obtained. Here, the measurement candidate set may be cleared by the RRM after the PHY layer of the terminal measures the SSBs corresponding to the SSB indexes in the measurement candidate set and reports the measured signal quality to the RRM (e.g., after operation S420).

In the above measurement method I and measurement method II, the SSBs corresponding to all SSB indexes are measured when the SSB measurement period satisfies the predetermined (or alternatively, given) time interval, and the SSBs corresponding to the SSB indexes in the measurement candidate set (generated in the previous SSB measurement period) are measured when the SSB measurement period does not satisfy the predetermined (or alternatively, given) time interval. The accuracy and flexibility of SSB index determination in the measurement candidate set is increased while saving measurement resources as well as terminal power consumption.

According to example embodiments, a predetermined (or alternatively, given) number of SSB indexes in a polling sequence may be added into the measurement candidate set, wherein the polling sequence may be a sequence generated in ascending or descending order of all SSB indexes.

According to example embodiments, the predetermined (or alternatively, given) number may be a number obtained from a first number minus a candidate number, wherein the candidate number is the number of SSB indexes already existing in the measurement candidate set, wherein the operation of adding the predetermined (or alternatively, given) number (e.g., the first number minus the candidate number) of SSB indexes in the polling sequence into the measurement candidate set may be performed in the case of the candidate number being less than or equal to the first number.

According to example embodiments, the predetermined (or alternatively, given) number of SSB indexes in the polling sequence that are not the same as (or similar to) the SSB indexes already existing in the measurement candidate set are added into the measurement candidate set.

In the process of determining the measurement candidate set, in example embodiments, in addition to adding the SSB indexes corresponding to the SSBs with measured signal quality greater than the predetermined (or alternatively, given) threshold into the measurement candidate set, the RRM of the terminal may also select the predetermined (or alternatively, given) number of SSB indexes from the polling sequence to be added into the measurement candidate set. The predetermined (or alternatively, given) threshold may be a default value, an empirical value, and vary depending on the specific parameter selected (e.g., RSRP or RSRQ), and the disclosure is not limited thereto. The polling sequence may be a sequence generated in ascending or descending order of all SSB indexes. Here, in the case of the ssbTomeasure not being configured, the all SSB indexes are all SSB indexes in the SSB burst set, and in the case of the ssbTomeasure being configured, all SSB indexes are the SSB indexes indicated by the ssbTomeasure. For example, if the ssbTomeasure is not configured, all indexes are the indexes of 8 SSBs in the SSB burst set in the cell (SSB indexes 0-7), and the polling sequence may be {0,1,2,3,4,5,6,7} or {7,6,5,4,3,2,1,0}. For another example, in the case of the ssbTomeasure being configured, the SSB index indicated by the ssbTomeasure may be, for example, {0,1,2,4} and the polling sequence may be {0,1,2,4} or {4,2,1,0}.

In example embodiments, the selection of the predetermined (or alternatively, given) number may involve following two measurement methods:

In measurement method III, the predetermined (or alternatively, given) number may be a fixed number, that is, after adding the SSB indexes corresponding to the SSBs with the measured signal quality greater than the predetermined (or alternatively, given) threshold into the measurement candidate set, the RRM of the terminal also selects a fixed number of SSB indexes from the polling sequence to be placed in the measurement candidate set. For example, the predetermined (or alternatively, given) number may be configured as 1 or 2 for the FRI band, and 4 or 8 for the FR2 band. It should be understood that the predetermined (or alternatively, given) number herein is only an example and the disclosure is not limited thereto. When selecting the predetermined (or alternatively, given) number of SSB indexes from the polling sequence to be added into the measurement candidate set, for example, in the case that the polling sequence is {0,1,2,3,4,5,6,7} and the predetermined (or alternatively, given) number is 2, in SSB measurement period P, SSB indexes {0,1} may be selected to be added into the measurement candidate set, in SSB measurement period P+1, SSB indexes {2,3} may be selected to be added into the measurement candidate set, and in SSB measurement period P+4, SSB indexes {0,1} may be selected to be added into the measurement candidate set again, and so on for subsequent SSB measurement periods, thus the SSB indexes are cyclically added into the polling sequence. In addition, if there is already an SSB index in the measurement candidate set that is the same as (or similar to) the SSB index selected from the polling sequence to be added into the measurement candidate set, the same SSB index (or a similar SSB index) may be skipped and the next index that is different may be continuously selected. For example, if SSB indexes to be added into the measurement candidate set is {2,3} and the SSB index 3 already exists in the measurement candidate set, the SSB index 3 may be skipped and the SSB indexes {2,4} in the polling sequence may be selected to be added into the measurement candidate set. In addition, if the ssbTomeasure is configured and the polling sequence is, for example, {0,1,2,4}, the SSB indexes in the polling sequence may be added cyclically in the order of {0,1}, {2,4}, {0,1}, {2,4} . . . .

For example, in the case of the polling sequence being {0,1,2,3,4,5,6,7} and the predetermined (or alternatively, given) number of 2, if SSB indexes in the polling sequence to be added for the current SSB measurement period is {0,1}, assuming that the existing measurement candidate set is {3,4,5} after adding the SSB indexes corresponding to the SSBs with the measured signal quality greater than the predetermined (or alternatively, given) threshold into the measurement candidate set, and the measurement candidate set after adding the SSB indexes in the polling sequence is {0,1,3,4,5}. Assuming that the existing measurement candidate set is {1,2,3}, the measurement candidate set after adding the SSB indexes in the polling sequence is {0,1,2,3,4}, at this time, the actual adding SSB indexes in the polling sequence are {0,4} which are not the same as (or similar to) the SSB indexes already existing in the measurement candidate set.

In measurement method IV, the predetermined (or alternatively, given) number may be a number obtained from the first number minus the candidate number. Here, it may be considered that the measurement candidate set having a fixed number (first number) of SSB indexes is generated in the measurement method IV. After adding the SSB indexes corresponding to the SSBs with the measured signal quality greater than the predetermined (or alternatively, given) threshold into the measurement candidate set, in the case that the number of SSB indexes in the measurement candidate set is less than or equal to the first number, the RRM of the terminal also selects the predetermined (or alternatively, given) number (e.g., first number minus the candidate number) of the SSB indexes from the polling sequence to be added into the measurement candidate set, so as to generate the measurement candidate set with the number of SSB indexes equaling to the first number. For example, the first number may be configured to be 4 for the FR1 band and 8 for the FR2 band, wherein the candidate number is the number of SSB indexes already existing in the measurement candidate set. It should be understood that the first number here is only an example and the disclosure is not limited thereto. For example, the first number is configured to 4. In the case that the number of SSB indexes in the measurement candidate set is 3 after adding the SSB indexes corresponding to the SSBs with measured signal quality greater than the predetermined (or alternatively, given) threshold into the measurement candidate set, the RRM of the terminal also selects one (e.g., 4 minus 3) SSB index from the polling sequence to be added into the measurement candidate set. The method of adding SSB indexes in the polling sequence in measurement method IV is the same as (or similar to) in the measurement method III, and is not repeated here.

According to example embodiments, a value of a counter for the SSB with the signal quality greater than the predetermined (or alternatively, given) threshold is set to 2, the value of the counter for the SSB with the signal quality less than or equal to the predetermined (or alternatively, given) threshold is subtracted (e.g., decremented) by 1, and the SSB index corresponding to the SSB with the value of the counter greater than 0, from among the SSBs with signal quality less than or equal to the predetermined (or alternatively, given) threshold, is added into the measurement candidate set. According to example embodiments, the value to which the counter is set for the SSB based on the SSB having a signal quality greater than the predetermined (or alternatively, given) threshold, and the value by which the counter for the SSB is decremented based on the SSB having a signal quality less than or equal to the predetermined (or alternatively, given) threshold, may vary (e.g., may be different from 2 and 1, respectively).

In example embodiments, the SSB indexes corresponding to the SSBs with the signal quality greater than the predetermined (or alternatively, given) threshold measured at a certain SSB measurement period (e.g., the period P) include, for example, SSB index 5, but the SSB indexes corresponding to the SSBs with the signal quality greater than the predetermined (or alternatively, given) threshold measured at the next SSB measurement period (e.g., period P+1) do not include 5. It may be that a signal fluctuation has occurred, and if not adding the SSB index 5 into the measurement candidate set, it may cause leakage of the measurement. Therefore, a counter for the SSB is also introduced in the disclosure to address this challenge, and the counters of a plurality of the SSBs in the burst set may be initialized to 0 or −1. In a certain SSB measurement period (e.g., the period P), whenever the signal quality of the SSB is greater than the predetermined (or alternatively, given) threshold (regardless of for the first time or again), the value of the counter for the SSB is set to 2, (e.g., the counter for the SSB corresponding to the SSB index 5 is set to 2), and the counter for the SSB with signal quality less than or equal to the predetermined (or alternatively, given) threshold is subtracted (e.g., decremented) by 1. In the next SSB measurement period (e.g., the period P+1), the signal quality of the SSB corresponding to SSB index 5 is less than or equal to the predetermined (or alternatively, given) threshold, and the counter for the SSB corresponding to SSB index 5 is 1 after being subtracted by 1. If the SSB index corresponding to the SSB with the value of the counter greater than 0 is added into the measurement candidate set, then in the next SSB measurement period (e.g., period P+1), the SSB index 5 will still be added into the measurement candidate set, thus avoiding (or reducing) the measurement leakage caused by signal fluctuation.

By adding SSB indexes in the polling sequence to the measurement candidate set, on one hand, all the SSB indexes may be polled and measured in a plurality of measurements, preventing the omission of desirable SSB measurement objects due to the movement of the terminal or the change of the channel conditions, etc., and improving the accuracy of the measurements. On the other hand, polling a small number of SSB indexes at different locations each time improves measurement flexibility while conserving measurement resources and terminal power consumption.

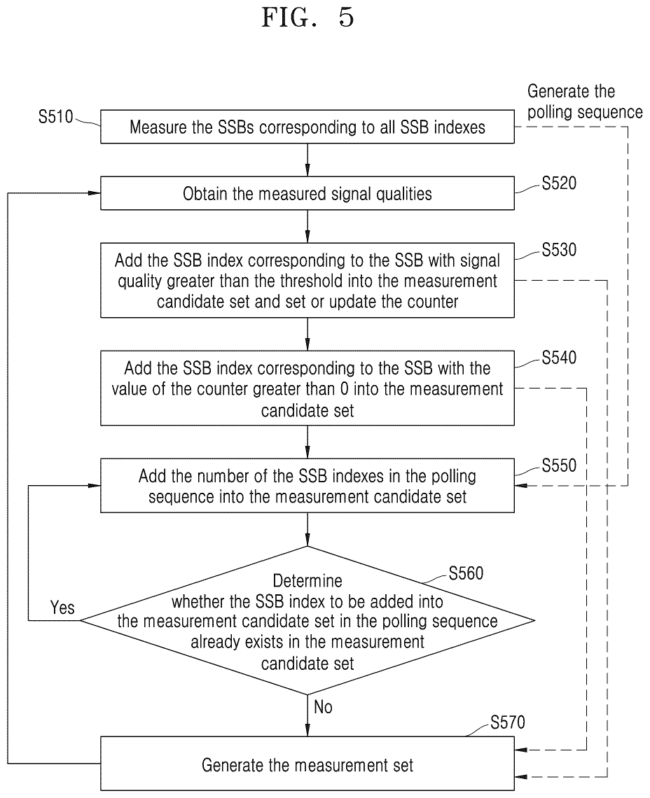

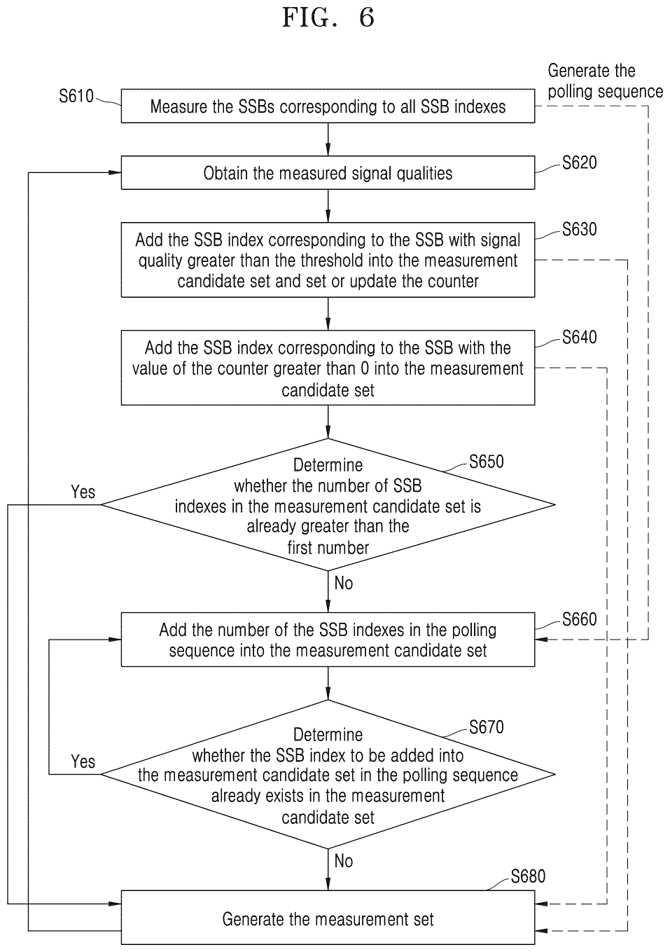

The specific flows of the measurement method III and the measurement method IV are described below with reference to FIG. 5 and FIG. 6. FIG. 5 illustrates a specific flowchart of measurement method III based on SSB indexes according to example embodiments.

Referring to FIG. 5, in the measurement method III, the RRM of the terminal selects a fixed number (predetermined (or alternatively, given) number) of SSB indexes from the polling sequence into the measurement candidate set.

In operation S510, the SSBs corresponding to all SSB indexes are measured. Specifically, after the SSB measurement starts, the terminal RRM instructs the PHY layer to measure the SSBs corresponding to all SSB indexes in the first SSB measurement period (e.g., the period P, where P is a positive integer). Also, a dashed line on the right side from operation S510 to operation S550 indicates the data flow direction, that is, the polling sequence in operation S550 is generated according to the sequence generated by the ascending or descending order of the all SSB indexes. Here, in the case of the ssbTomeasure not being configured, the all SSB indexes are all SSB indexes in the SSB burst set, and in the case of the ssbTomeasure being configured, the all SSB indexes are the SSB indexes indicated by the ssbTomeasure.

In operation S520, the measured signal qualities are obtained. Specifically, the measured signal qualities may be reported to the RRM after the SSB measurements are performed by the PHY layer, and thus the measured signal qualities are obtained by the RRM. Herein, the measured signal qualities may be the signal qualities measured for the SSBs corresponding to the all SSB indexes, or they may be the signal qualities measured for the SSBs corresponding to the SSB indexes in the measurement candidate set.

In operation S530, the SSB index corresponding to the SSB with signal quality greater than the predetermined (or alternatively, given) threshold is added into the measurement candidate set and the counter for the SSB is set or updated. Specifically, setting or updating the value of the counter may include setting the counter for the SSB with the signal quality greater than the predetermined (or alternatively, given) threshold to 2 and subtracting 1 from the counter for the SSB with the signal quality less than or equal to the predetermined (or alternatively, given) threshold.

In operation S540, the SSB index corresponding to the SSB with the value of the counter greater than 0, from among the SSBs with signal quality less than or equal to the predetermined (or alternatively, given) threshold, is added into the measurement candidate set. In this operation, if an SSB index corresponding to the SSB with the measured signal quality greater than the predetermined (or alternatively, given) threshold (e.g., the SSB index 5) in the previous SSB measurement period (e.g., the period P), and the SSB index corresponding to the SSB with the measured signal quality less than or equal to the predetermined (or alternatively, given) threshold in the current SSB measurement period (e.g., the period P+1), due to the existence of the counter (at this time, the value of the counter is 1), the SSB index (e.g., the SSB index 5) may also be added into the measurement candidate set, thus avoiding (or reducing) measurement leakage due to signal fluctuation. However, due to the operation of subtracting by 1 in operation S530, if in the next SSB measurement period (e.g., the period P+2), the SSB index corresponding to the SSB with the signal quality still less than or equal to the predetermined (or alternatively, given) threshold, the SSB index is no longer added into the measurement candidate set because the value of the counter has been reduced to 0 at this time.

Here, dashed lines on the right side from operation S530 and operation S540 to operation S570, respectively, indicate the flow direction of the data, that is, the addition of candidate SSB indexes from operation S530 and operation S540, respectively, into the measurement candidate set in operation S570.

In operation S550, the predetermined (or alternatively, given) number of SSB indexes in the polling sequence are added into the measurement candidate set. For example, the predetermined (or alternatively, given) number may be configured to 1 or 2 for the FR1 band and 4or 8 for the FR2 band.

In operation S560, it is determined whether the SSB index to be added into the measurement candidate set in the polling sequence already exists in the measurement candidate set. If “yes”, the SSB indexes in the polling sequence may continue to be added, and it may be continuously determined whether the SSB index to be added already exists in the measurement candidate set, until the predetermined (or alternatively, given) number of SSB indexes that are not the same as (or similar to) the SSB indexes already existing in the measurement candidate set are added into the measurement candidate set. If “No”, the procedure proceeds to operation S570.

In operation S570, the measurement candidate set is generated. The above operation S530-operation S570 may be operated by the RRM of the terminal.

In addition, in the case that the measurement candidate set is generated, at the arrival of the next SSB measurement period (e.g., period P+1), the measurements may be performed only for the SSBs corresponding to the SSB indexes in the measurement candidate set and the procedure proceeds to operation S520, thereby the measured signal qualities are obtained. Here, the measurement candidate set may be cleared by the RRM after the PHY layer of the terminal measures the SSBs corresponding to the SSB indexes in the measurement candidate set and reports the measured signal qualities to the RRM (e.g., after operation S520).

FIG. 6 illustrates a specific flowchart of measurement method IV based on SSB indexes according to example embodiments.

Referring to FIG. 6, the measurement method IV may be considered to generate the measurement candidate set having a fixed number (first number) of SSB indexes. Operations S610-S640 in FIG. 6 are the same as (or similar to) operations S510-S540 in FIG. 5, so redundant descriptions are omitted.

At this time, a dashed line on the right side from operation S610 to operation S660 indicates the data flow direction, that is, the polling sequence in operation S660 is generated according to the sequence generated by the ascending or descending order of all SSB indexes. Dashed lines on the right side from operation S630 and operation 6540 to operation S570, respectively, also indicate the data flow direction, that is, the addition of candidate SSB indexes from operation 6530 and operation S640, respectively, into the measurement candidate set in operation S680.

In operation S650, it is determined whether the number of SSB indexes in the measurement candidate set is already greater than the first number. If yes, the operation to add the SSB indexes in the polling sequence (operation S660 and operation S670) is skipped and the procedure proceeds directly to operation S680, the measurement candidate set is generated. The number of SSB indexes in the measurement candidate set may exceed the first number at this time. If not, the procedure proceeds to operation S660.

In operation S660, the predetermined (or alternatively, given) number (e.g., the first number minus the candidate number) of the SSB indexes in the polling sequence are added into the measurement candidate set. For example, the first number may be configured to 4 for the FR1 band and 8 for the FR2 band, wherein the candidate number is the number of SSB indexes already existing in the measurement candidate set.

In operation S670, it is determined whether the SSB index to be added into the measurement candidate set in the polling sequence already exists in the measurement candidate set. If “yes”, the SSB indexes in the polling sequence may continue to be added, and it may be continuously determined whether the SSB index to be added already exists in the measurement candidate set, until the predetermined (or alternatively, given) number (e.g., the first number minus the candidate number) of SSB indexes that are not the same as (or similar to) the SSB indexes already existing in the measurement candidate set are added into the measurement candidate set. If “No”, the procedure proceeds to operation S680.

In operation S680, the measurement candidate set is generated. The above operations S630-S680 may be operated by the RRM of the terminal.

In addition, in the case that the measurement candidate set is generated, at the arrival of the next SSB measurement period (e.g., the period P+1), the measurements may be performed only for the SSBs corresponding to the SSB indexes in the measurement candidate set and the procedure proceeds to operation S620, thereby the measured signal qualities are obtained. The measurement candidate set may be cleared by the RRM after the PHY layer of the terminal measures the SSBs corresponding to the SSB indexes in the measurement candidate set and reports the measured signal qualities to the RRM (e.g., after operation S620).

In the above measurement method III and measurement method IV, the SSBs corresponding to the SSB indexes in the measurement candidate set are measured and the SSB indexes in the polling sequence are added into the measurement candidate set. The accuracy and flexibility of SSB index determination in the measurement candidate set is increased while saving measurement resources as well as terminal power consumption.

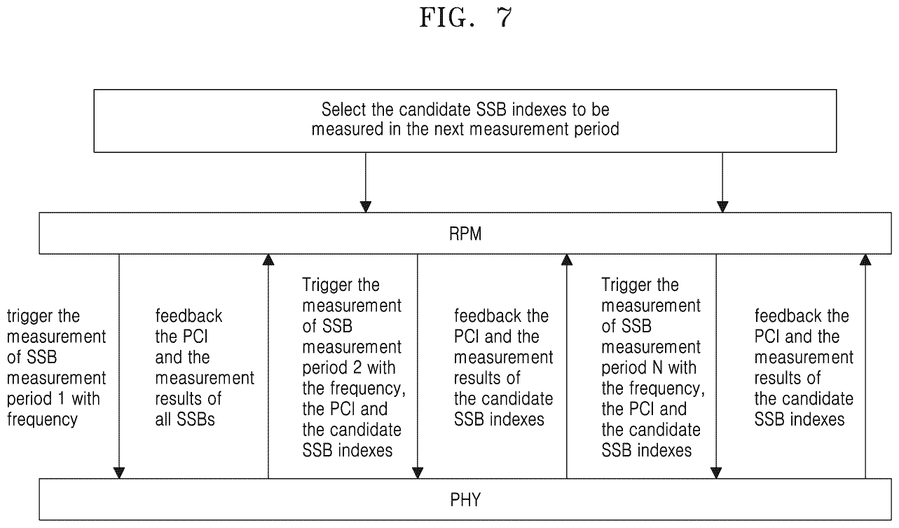

FIG. 7 illustrates a diagram of a measurement method based on SSB indexes according to example embodiments.

The measurement method based on SSB indexes may be applied to the measurement for the serving cell or neighboring cell by the terminal 101, may be applied to the intra-frequency measurement or the inter-frequency measurement, and may also be applied to the measurement of the terminal 101 in the connected state or in the idle state, and the disclosure is not limited thereto. In addition, the terminal 101 obtains SSB frequencies by RRC signaling when it is in the connected state, and obtains SSB frequencies by the system information block (SIB) message at the time of initial connection when it is in the idle state.

Referring to FIG. 7, the terminal includes the RRM module and the PHY layer, and the RRM module and the PHY layer are involved in the measurement method based on SSB indexes of the disclosure.

After the SSB measurement starts, in the first SSB measurement period (SSB measurement period 1), the RRM instructs the PHY layer to measure all SSBs in the SSB burst set of the cell (the SSB indexes indicated by the ssbTomeasure if the ssbTomeasure is configured) based on the obtained SSB frequencies. At this time, the measurement parameters carried by the RRM to trigger the PHY layer measurement may include the SSB frequencies. After the PHY layer measurement is completed, the PHY layer reports (feeds back) the PCI of the measured cell and the measurement results (e.g., signal quality) of all SSBs to the RRM, and the RRM may select the appropriate SSB indexes as candidate SSB indexes (added into the measurement candidate set) by various means based on the measured signal qualities.

In SSB measurement period 2, the RRM may instruct the PHY layer to measure the SSBs corresponding to the candidate SSB indexes based on the generated candidate SSB indexes (the measurement candidate set). At this time, the measurement parameters carried by the RRM to trigger the PHY layer measurement may include the SSB frequencies, the PCI of the cell and the candidate SSB indexes. After the PHY layer measurement is completed, the PHY layer reports (feeds back) the PCI of the measured cells and the measurement results (e.g., signal quality) of the candidate SSB indexes to the RRM, and the RRM may continue to select the appropriate SSB indexes as new candidate SSB indexes by various means based on the measured signal qualities.

Subsequent SSB measurement periods (e.g., SSB measurement period 3, 4, etc.) may perform the same operations as (or similar operations to those) in the SSB measurement period 2, which are not repeated here.

The above-mentioned selection of appropriate SSB indexes by various means may include, for example, adding the SSB index corresponding to the SSB with measured signal quality greater than a predetermined (or alternatively, given) threshold (according to certain rules) into the measurement candidate set. And also, the accuracy and flexibility of SSB index determination in the measurement candidate set may be increased by measuring the SSBs corresponding to all SSB indexes when the SSB measurement period satisfies the predetermined (or alternatively, given) time interval, and measuring the SSBs corresponding to SSB indexes in the measurement candidate set when the SSB measurement period does not satisfy the predetermined (or alternatively, given) time interval (e.g., measurement methods I and II), and by adding SSB indexes in a polling sequence into the measurement candidate set (e.g., measurement methods III and IV).

As described above, according to the measurement method of the disclosure, by selecting the SSB index corresponding to the SSB with the measured signal quality greater than a threshold to be measured in the next SSB measurement period, measurements are focused on one or some SSB indexes corresponding to the SSBs, which avoids (or reduces) the measurements of invalid SSBs and weak SSBs, and conserves measurement resources as well as terminal power consumption is achieved. Also, the accuracy and flexibility of SSB index determination in the measurement candidate set may be increased according to the measurement method of the present disclosure.

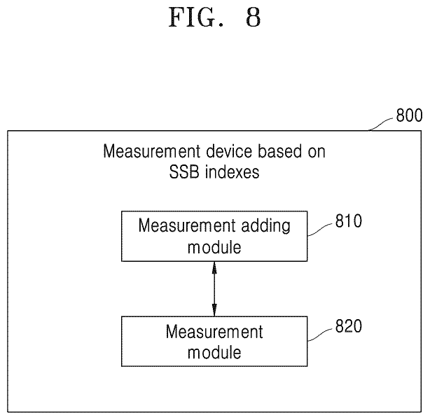

FIG. 8 illustrates a block diagram of a measurement device based on SSB indexes according to example embodiments. The measurement device here may be a terminal 101.

Referring to FIG. 8, the measurement device based on synchronization signal and PBCH block (SSB) indexes 800 may include a measurement adding module 810 and/or an SSB measurement module 820. The measurement adding module 810 may add an SSB index corresponding to an SSB with a measured signal quality greater than a predetermined (or alternatively, given) threshold into a measurement candidate set, and the SSB measurement module 820 may measure the SSB corresponding to the SSB index in the measurement candidate set in next SSB measurement period.

According to example embodiments, the SSB measurement module 820 may measure SSBs corresponding to all SSB indexes in a first SSB measurement period.

According to example embodiments, the measurement adding module 810 may perform the operation of the adding into the measurement candidate set and the SSB measurement module 820 may perform the operation of the measuring in the next SSB measurement period, in the case of the next SSB measurement period not satisfying a predetermined (or alternatively, given) time interval. The SSB measurement module 820 may measure SSBs corresponding to all SSB indexes in the next SSB measurement period, in the case of the next SSB measurement period satisfying the predetermined (or alternatively, given) time interval.

According to example embodiments, the predetermined (or alternatively, given) threshold is a first threshold. Here the measurement adding module 810 may add the SSB index corresponding to the SSB with the signal quality greater than the first threshold and its adjacent SSB indexes into the measurement candidate set, and add, in the case of all signal qualities being less than or equal to the first threshold, the SSB index corresponding to the SSB with the maximum (or highest) value in the signal qualities and its adjacent SSB indexes into the measurement candidate set.

According to example embodiments, the predetermined (or alternatively, given) threshold is a second threshold. Herein, the measurement adding module 810 may add the SSB index corresponding to the SSB with the signal quality greater than the second threshold into the measurement candidate set, and the SSB measurement module 820 may not perform measurement in the case of the measurement candidate set being empty.

According to example embodiments, the predetermined (or alternatively, given) time interval is a predetermined (or alternatively, given) interval number of SSB measurement periods. For example, for the FR1 band, the predetermined (or alternatively, given) interval number may be configured to 4, and for the FR2 band, the predetermined (or alternatively, given) interval number may be configured to 8.

According to example embodiments, the measurement device based on synchronization signal and PBCH block (SSB) indexes 800 may further includes a poll adding module 830 (not shown). The poll adding module 830 may add a predetermined (or alternatively, given) number of SSB indexes in a polling sequence into the measurement candidate set, wherein the polling sequence is a sequence generated in ascending or descending order of all SSB indexes. For example, for the FR1 band, the predetermined (or alternatively, given) number may be configured to 1 or 2, and for the FR2 band, the predetermined (or alternatively, given) number may be configured to 4 or 8.

According to example embodiments, the predetermined (or alternatively, given) number is a number obtained from a first number minus a candidate number, wherein the candidate number is the number of SSB indexes already existing in the measurement candidate set. The poll adding module 830 may add the predetermined (or alternatively, given) number (e.g., the first number minus the candidate number) of the SSB indexes in the polling sequence into the measurement candidate set, in the case of the candidate number being less than or equal to the first number. For example, for the FR1 band, the first number may be configured to 4, and for the FR2 band, the first number may be configured to 8.

According to example embodiments, the poll adding module 830 may add the predetermined (or alternatively, given) number of the SSB indexes in the polling sequence that are not the same as (or similar to) SSB indexes already existing in the measurement candidate set into the measurement candidate set.

According to example embodiments, the measurement device based on synchronization signal and PBCH block (SSB) indexes 800 may further includes a counter setting module 840 (not shown). The counter setting module 840 may set a value of a counter for the SSB with the signal quality greater than the predetermined (or alternatively, given) threshold to 2, subtract 1 from the value of the counter for the SSB with the signal quality less than or equal to the predetermined (or alternatively, given) threshold, and add the SSB index corresponding to the SSB with the value of the counter greater than 0, from among the SSBs with signal quality less than or equal to the predetermined (or alternatively, given) threshold, into the measurement candidate set.

According to example embodiments, the all SSB indexes are all SSB indexes in the SSB burst set, in the case of location information of actual occurrence of the SSB in an SSB burst set not being configured, and the all SSB indexes are SSB indexes indicated by the location information, in the case of the location information being configured.

According to example embodiments, the measurement device based on synchronization signal and PBCH block (SSB) indexes 800 may further includes a candidate set clearing module 850 (not shown). The candidate set clearing module 850 may clear the measurement candidate set, and return to the operation of adding the SSB index corresponding to the SSB with a measured signal quality greater than the predetermined (or alternatively, given) threshold into the measurement candidate set of the measurement adding module 810.

As described above, the measurement device according to the disclosure, by selecting the SSB index corresponding to the SSB with the measured signal quality greater than a threshold to be measured in the next SSB measurement period, measurements are focused on one or some SSB indexes corresponding to the SSBs, which avoids (or reduces) the measurements of invalid SSBs and weak SSBs, and conserves measurement resources as well as terminal power consumption. Also, the accuracy and flexibility of SSB index determination in the measurement candidate set may be increased according to the measurement method of the present disclosure.

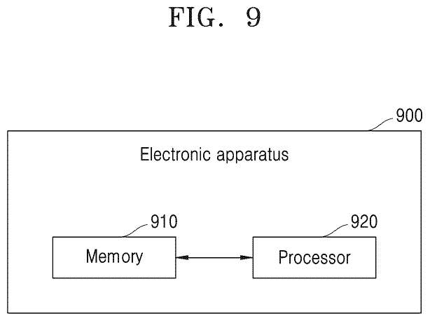

FIG. 9 illustrates a block diagram of an electronic apparatus according to example embodiments. For example, the electronic apparatus 900 may be the terminal 101 of example embodiments of the disclosure. Referring to FIG. 9, the electronic apparatus 900 may include at least one memory 910 and at least one processor 920. The at least one memory may store a set of computer executable instructions therein, and when a set of computer-executable instructions (e.g., the set of computer executable instructions stored in the at least one memory 910) is executed by the at least one processor, the measurement method based on SSB indexes according to example embodiments of the disclosure may be executed.

Here, the electronic apparatus may not be a single electronic apparatus, but may also be any collection of devices or circuits capable of executing the instructions (or instruction set) individually or in combination. The electronic apparatus may also be part of an integrated control system or system manager, or may be configured to be an electronic apparatus connecting via a local or remote (e.g., via wireless transmission) interface.

In an electronic apparatus, the processor may include a central processing unit (CPU), a graphic processing unit (GPU), a programmable logic device, a dedicated processor system, a microcontroller, and/or a microprocessor. As an example and not a limitation, a processor may also include an analog processor, a digital processor, a microprocessor, a multi-core processor, a processor array, a network processor, and/or the like.

The processor may run instructions or code stored in the memory, wherein the memory may also store data. The instructions and/or data may also be sent, and/or received, over a network via a network interface device, wherein the network interface device may employ any known transmission protocol.

The memory may be integrated with the processor, for example, by arranging RAM or flash memory within an integrated circuit microprocessor. In addition, the memory may include a separate device, such as an external disk drive, a storage array, or other storage device. The memory and the processor may be operationally coupled or may communicate with each other, for example, via I/O ports, network connections, etc., so that the processor may read the files stored in the memory.

In addition, the electronic apparatus may also include a video display (e.g., LCD) and a user interface (such as a keyboard, mouse, touch input device, etc.). All components of the electronic apparatus may be connected to each other via a bus and/or network.

According to example embodiments, a computer-readable storage medium may also be provided, wherein a computer program is stored thereon, the program when executed may implement the measurement method based on SSB indexes according to the present disclosure. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), solid state drive (SSD), card-based memory (such as, multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as a terminal, client, host, agent, server, etc., and furthermore, in one example, the computer program and any associated data, data files and/or data structures are distributed on a networked computer system such that the computer program and any associated data, data files and/or data structures are stored, accessed, and/or executed in a distributed manner by one or more processors or computers.

As described above, the measurement method and the measurement device based on SSB indexes according to the disclosure, by selecting the SSB index corresponding to the SSB with the measured signal quality greater than a threshold to be measured in the next SSB measurement period, measurements are focused on one or some SSB indexes corresponding to the SSBs, which avoids (or reduces) the measurements of invalid SSBs and weak SSBs, and conserves measurement resources as well as terminal power consumption. Also, the accuracy and flexibility of SSB index determination in the measurement candidate set may be increased according to the measurement method of the present disclosure.

Conventional devices and methods for performing communication based on SSBs always measure (e.g., in each measurement period) the signal quality of all of the SSBs in an SSB burst set in circumstances in which location information (e.g., the network parameter ssbTomeasure) has not been configured. However, only some of the SSBs in the SSB burst are useful to the conventional devices (e.g., for use in performing synchronization with a base station due to, for instance, being invalid or weak SSBs). Accordingly, the conventional devices and methods experience excessive resource consumption (e.g., power, processor, delay, etc.) due to measurement of the signal quality of SSBs that are not useful to the conventional devices.

However, according to example embodiments, improved devices and methods are provided for performing communication based on SSBs. For example, the improved devices and methods may measure the signal quality of a portion of SSBs in an SSB burst set in a measurement period in circumstances in which the location information has not been configured. The portion of the SSBs may include those SSBs having a higher signal quality (e.g., a signal quality greater than a threshold), and thus, may represent SSBs most likely to be of use to the improved devices (e.g., for use in performing synchronization with a base station). Accordingly, the improved devices and methods overcome the deficiencies of the conventional devices and methods to at least reduce resource consumption (e.g., power, processor, delay, etc.).

Also, according to example embodiments, the improved devices and methods may re-determine the portion of the SSBs for which the signal quality is to be measured from among the SSBs in the SSB burst set in response to determining a time interval has expired. In so doing, the improved devices and methods may adapt the portion of the SSBs in consideration of possible movement of the improved devices, changing communication channel conditions, etc. Additionally, according to example embodiments, the improved devices and methods may use a counter to avoid or reduce rapid removal of an SSB from among the portion of the SSBs for which the signal quality is to be measured. In so doing, the improved devices may overcome or reduce the effects of signal fluctuation (e.g., due to varying communication channel conditions).

According to example embodiments, operations described herein as being performed by the SSB measurement system 100, the terminal 101, the base station apparatus 102, the RRM of the terminal, the PHY layer of the terminal, the measurement device based on SSB indexes 800, the measurement adding module 810, the SSB measurement module 820, the poll adding module 830, the counter setting module 840, the candidate set clearing module 850, the electronic apparatus 900 and/or the at least one processor 920 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Example embodiments of the disclosure will readily come to the mind of those skilled in the art upon consideration of the specification and practice of the inventive concepts disclosed herein. This application is intended to cover any variations, uses, or adaptations of the present disclosure that follow the general principles of the disclosure and include commonly known or customary technical means in the art that are not disclosed herein. Example embodiments provided in the specification are merely examples, and the scope and spirit of the disclosure is indicated by the following claims.

It is to be understood that the disclosure is not limited to the precise structure already described above and illustrated in the accompanying drawings, and that various modifications and changes may be made without departing from its scope. The scope of the present disclosure is limited only by the appended claims.

1. A measurement method based on synchronization signal and PBCH block (SSB) indexes, the method comprising:
adding a first SSB index corresponding to a first SSB into a first measurement candidate set based on the first SSB having a first measured signal quality value greater than a threshold; and
measuring a signal quality value for each SSB corresponding to a respective SSB index in the first measurement candidate set in a first SSB measurement period.

2. The method of claim 1, further comprising:
measuring first respective signal quality values for SSBs corresponding to all SSB indexes among a first set of SSB indexes in a second SSB measurement period, the second SSB measurement period preceding the first SSB measurement period.

3. The method of claim 1, wherein
the adding the first SSB index into the first measurement candidate set is performed based on the first SSB measurement period not satisfying a time interval condition; and
the method further comprises measuring second respective signal quality values for SSBs corresponding to all SSB indexes among a first set of SSB indexes in a third SSB measurement period based on the third SSB measurement period satisfying the time interval condition.

4. The method of claim 3, further comprising:
measuring third respective signal quality values for SSBs corresponding to all SSB indexes among the first set of SSB indexes in a fourth SSB measurement period to obtain a plurality of signal quality values;
performing a first operation in response to at least one of the plurality of signal quality values being greater than the threshold, the first operation including adding each respective SSB index among the first set of SSB indexes for which a corresponding SSB has a signal quality value greater than the threshold and at least one first adjacent SSB index into a second measurement candidate set, the at least one first adjacent SSB index being adjacent to the respective SSB index; and
performing a second operation in response to none of the plurality of signal quality values being greater than the threshold, the second operation including adding a second SSB index among the first set of SSB indexes and at least one second adjacent SSB index into the second measurement candidate set, the second SSB index corresponding to an SSB having a highest signal quality value among the plurality of signal quality values, and the at least one second adjacent SSB index being adjacent to the second SSB index.

5. The method of claim 3, further comprising:
measuring third respective signal quality values for SSBs corresponding to all SSB indexes among the first set of SSB indexes in a fourth SSB measurement period to obtain a plurality of signal quality values;
adding each respective SSB index among the first set of SSB indexes for which a corresponding SSB has a signal quality value greater than the threshold into a second measurement candidate set in response to at least one of the plurality of signal quality values being greater than the threshold; and
skipping measurement of a signal quality value for each SSB corresponding to a respective SSB index in the second measurement candidate set in a fifth SSB measurement period in response to the second measurement candidate set being empty.

6. The method of claim 3, wherein the time interval condition is based on an interval number of SSB measurement periods.

7. The method of claim 1, further comprising:
adding a number of SSB indexes of a polling sequence into the first measurement candidate set after the adding the first SSB index into the first measurement candidate set, the polling sequence including all SSB indexes among a first set of SSB indexes in ascending or descending order.

8. The method of claim 7, wherein
the number of SSB indexes is a difference between a first number and a candidate number, the candidate number being the number of SSB indexes included in the first measurement candidate set prior to the adding the number of SSB indexes to the first measurement candidate set being performed; and
the adding the number of the SSB indexes into the first measurement candidate set is performed in response to the candidate number being less than or equal to the first number.

9. The method of claim 7, wherein the adding the number of SSB indexes of the polling sequence into the first measurement candidate set comprises adding SSB indexes of the polling sequence that are not the same as SSB indexes already in the first measurement candidate set.

10. The method of claim 7, further comprising:
setting a value of a first counter for the first SSB to 2;
subtracting 1 from a value of a second counter for a second SSB, the second SSB having a signal quality value less than or equal to the threshold; and
adding each respective SSB index among a second set of SSB indexes corresponding to an SSB having a counter with a value greater than 0 into the first measurement candidate set, the second set of SSB indexes including SSB indexes corresponding to SSBs having measured signal quality values less than or equal to the threshold, and the adding each respective SSB index into the first measurement candidate set being performed before the adding the number of SSB indexes into the first measurement candidate set.

11. The method of claim 2, wherein
the first set of SSB indexes includes all SSB indexes in an SSB burst set in response to location information of occurrence of SSBs in the SSB burst set not being configured; and
the first set of SSB indexes includes SSB indexes indicated by the location information in response to the location information being configured.

12. The method of claim 1, further comprising:
clearing the first measurement candidate set after the measuring the signal quality value in the first SSB measurement period; and
repeating the adding the first SSB index corresponding to the first SSB into the first measurement candidate set based on the first SSB having a second measured signal quality greater than the threshold into the first measurement candidate set after the clearing.

13. A measurement device based on synchronization signal and PBCH block (SSB) indexes, the device comprising:
processing circuitry configured to,
add a first SSB index corresponding to a first SSB into a first measurement candidate set based on the first SSB having a first measured signal quality value greater than a threshold, and
measure a signal quality value for each SSB corresponding to a respective SSB index in the first measurement candidate set in a first SSB measurement period.

14. The device of claim 13, wherein the processing circuitry is configured to measure first respective signal quality values for SSBs corresponding to all SSB indexes among a first set of SSB indexes in a second SSB measurement period, the second SSB measurement period preceding the first SSB measurement period.

15. The device of claim 13, wherein the processing circuitry is configured to:
add the first SSB index into the first measurement candidate set based on the first SSB measurement period not satisfying a time interval condition; and
measure second respective signal quality values for SSBs corresponding to all SSB indexes among a first set of SSB indexes in a third SSB measurement period based on the third SSB measurement period satisfying the time interval condition.

16. The device of claim 15, wherein the processing circuitry is configured to:
measure third respective signal quality values for SSBs corresponding to all SSB indexes among the first set of SSB indexes in a fourth SSB measurement period to obtain a plurality of signal quality values;
perform a first operation in response to at least one of the plurality of signal quality values being greater than the threshold, the first operation including adding each respective SSB index among the first set of SSB indexes for which a corresponding SSB has a signal quality value greater than the threshold and at least one first adjacent SSB index into a second measurement candidate set, the at least one first adjacent SSB index being adjacent to the respective SSB index; and
perform a second operation in response to none of the plurality of signal quality values being greater than the threshold, the second operation including adding a second SSB index among the first set of SSB indexes and at least one second adjacent SSB index into the second measurement candidate set, the second SSB index corresponding to an SSB having a highest signal quality value among the plurality of signal quality values, and the at least one second adjacent SSB index being adjacent to the second SSB index.

17. The device of claim 15, wherein the processing circuitry is configured to:
measure third respective signal quality values for SSBs corresponding to all SSB indexes among the first set of SSB indexes in a fourth SSB measurement period to obtain a plurality of signal quality values;
add each respective SSB index among the first set of SSB indexes for which a corresponding SSB has a signal quality value greater than the threshold into a second measurement candidate set in response to at least one of the plurality of signal quality values being greater than the threshold; and
skipping measurement of a signal quality value for each SSB corresponding to a respective SSB index in the second measurement candidate set in a fifth SSB measurement period in response to the second measurement candidate set being empty.

18. The device of claim 15, wherein the time interval condition is based on an interval number of SSB measurement periods.

19. The device of claim 13, wherein the processing circuitry is configured to add a number of SSB indexes of a polling sequence into the first measurement candidate set after the addition of the first SSB index into the first measurement candidate set, the polling sequence including all SSB indexes among a first set of SSB indexes in ascending or descending order.

20-25. (canceled)

26. A non-transitory computer readable storage medium storing a computer program that, when executed by processing circuitry, causes the processing circuitry to perform a method, the method comprising:
adding a first synchronization signal and PBCH block (SSB) index corresponding to a first SSB into a first measurement candidate set based on the first SSB having a first measured signal quality value greater than a threshold, and
measuring a signal quality value for each SSB corresponding to a respective SSB index in the first measurement candidate set in a first SSB measurement period.
